(19) United States
(12) Patent Application Publication
(10) Pub. No.: US 2018/0130167 A1
(43) Pub. Date: May 10, 2018

(54) Multi-Display Interaction

(71) Applicant: Alibaba Group Holding Limited, Grand Cayman (KY)

(72) Inventors: Kai Mao, Hangzhou (CN); Cong Shao, Hangzhou (CN); Yihui Liu, Hangzhou (CN)

(21) Appl. No.: 15/809,873

(22) Filed: Nov. 10, 2017

(30) Foreign Application Priority Data
Nov. 10, 2016 (CN) 201610997809.5

(51) Int. Cl. G06T 1/00; G06F 17/30; G06F 3/0484; H04W 4/02

(52) U.S. Cl. CPC G06T 1/0007; G06F 17/30058; G06F 3/048; H04W 4/02; G06F 3/0484

(57) ABSTRACT

A client terminal starts an image capture apparatus at a first terminal device when the client terminal receives a multi-display interaction request, to capture an image at a target display interface at a second terminal device. The client terminal determines a target event and target material information correlated with the target event. The target event is displayed at the second terminal device. The client terminal provides the target material information and corresponding animation effects with the image captured by the image capture apparatus. The corresponding animation effects animate a process of the target material information leaving the display at the second terminal device and entering a display of the first terminal. The techniques of the present disclosure make the interaction process more realistic and improve user engagements.

### CROSS REFERENCE TO RELATED PATENT APPLICATIONS

This application claims priority to and is a continuation of Chinese Patent Application No. 201610997809.5, filed on 10 Nov. 2016, entitled “Method and Device for Multi-Display Interaction,” which is hereby incorporated by reference in their entirety.

### TECHNICAL FIELD

The present disclosure relates to the technical field of multi-display interaction, and, more particularly, to a method and apparatus for implementing multi-display interaction.

### BACKGROUND

Multi-display interaction refers to a series of operations of transmission, analysis, display, control, etc. of multimedia (audio, video, picture) content via wireless network connection, on different multimedia terminal devices (such as between a mobile phone and a TV, etc.) The display content is shared on different platform devices, which enriches the user's multimedia life.

In conventional techniques, the interaction from the television terminal to the mobile terminal is usually realized by means of a graphic code. For example, a QR code relating to a program currently being played is displayed on a television screen, the user scans the QR code by using the scan function of an application that is installed in the mobile phone, and the QR code is analyzed in the mobile terminal to show the specific interactive content, and so on.

Although the conventional techniques achieve the interaction between the mobile phones and the TV to a certain extent, the implementation is inflexible, and the user engagement is low. For example, the interface only prompts the user to direct the camera of the mobile phone to the screen of the TV. However, there is not an efficient and wise method that lets the user quickly understand the content to be scanned on the screen of the TV. There is also no real-time feedback that lets the user know whether the camera of the phone captures the correct content on the screen of the TV and helps the user to quickly adjust scanning position to scan or capture correct content on the screen of the TV. Therefore, it becomes a technical problem to improve multi-screen interaction and user engagement.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure. The present disclosure provides a method and device for multi-display interaction, which makes the interaction process more vivid and real, which improves the user engagement.

The present disclosure provides an example method for multi-display interaction, applicable to a client terminal, comprising:

starting, by a client terminal, an image capture apparatus at a first terminal device when a client terminal receives a multi-display interaction request, to capture an image of a target display interface at a second terminal device;

determining a target event and target material information correlated with the target event, the target event being displayed at the second terminal device; and

providing the target material information and a corresponding animation effect with the image, the corresponding animation effect animating a process of the target material information leaving a display of the second terminal device and entering a display of the first terminal device.

For example, the client terminal is the first terminal device. Alternatively, the client terminal is located or installed at the first terminal device. For another example, the client terminals are client sides of an application including both server and client sides. There are multiple client terminals. A first client terminal is installed at the first terminal device and a second client terminal is installed at the second terminal device. The first client terminal and the second client terminal may directly communicate with each other or communicate via the server side of the application.

For example, the method further comprises:

receives a notification message provided by a server that the second terminal device is to play the target event, prior to receiving the multi-display interaction request; and

presenting a prompt message regarding the target event at a user interface of the first terminal device or the second terminal device according to the notification message.

For example, the method further comprises:

presents an item at the user interface for a user to initiate the multi-display interaction request.

For example, the method further comprises:

providing, a virtual graph representing an exterior shape of the second terminal device at an image capture region of a user interface at the first terminal device or the second terminal device to guide.

For example, the virtual graph guides a user to adjust a position of the first terminal device and a distance between the first terminal device and the second terminal device to focus the image capture apparatus at the display of the second terminal device.

For example, the method further comprises:

providing an icon within the virtual graph, the icon representing a target program source at the display of the second terminal device.

For example, the first terminal device is a mobile device such as a cell phone, the second terminal device is a TV, and the target program source is a target TV station.

For example, the method further comprises:

changing a presentation of the virtual graph to provide feedback information when the image capture apparatus focuses on the target display interface of the second terminal device.

For example, the method further comprises:

providing prompt information that the target material is to appear at the user interface when determining that the target event is being played at the second terminal device minimizing the virtual graph to be invisible.

For example, the providing the prompt information that the target material is to appear at the user interface includes:

open a shaking mode of the first terminal device; or

providing a content in the virtual graph.

For example, the method further comprises:

determining that the image capture apparatus does not focus on the target display interface of the second terminal device based on an image captured by the image capture apparatus; and

providing a corresponding prompt message.

For example, a preset region in the target display interface includes key element information; and the determining that the image capture apparatus does not focus on the target display interface of the second terminal device based on the image captured by the image capture apparatus includes:

analyzing the image;

determining that the image includes the key element information; and

determining that the image capture apparatus focuses on the target display interface of the second terminal device in response to determining that the image includes the key element information.

For example, the providing the target material information and the corresponding animation effect with the image includes:

providing an animation effect that the target material information moves along a direction from the display of the second terminal device to the display of the first terminal device

For example, the providing the target material information and the corresponding animation effect with the image further includes:

providing an animation effect of a first screen hit that the target material information hits the display of the second terminal device and leaves the second terminal device; and

providing an animation effect of a second screen hit that the target material information hits the display of the first terminal device and enters the first terminal device

For example, the target event is a live show or live broadcast.

The present disclosure provides an example method for multi-display interaction, applicable to a server, comprising:

determining, by the server, at least one client terminal that participates in multi-display interaction;

determining play progress information at a second terminal device; and

in response to determining that the second terminal device is playing a target event, providing target material information correlated with the target event to the at least one client terminal.

For example, the method further comprises:

instructing a client terminal to provide the target material information and corresponding animation effects with an image captured by an image capture apparatus at a first terminal device, the corresponding animation effects animating a process of the target material information leaving a display of a second terminal device and entering a display of the first terminal device.

For example, the method further comprises:

providing a notification message that the target event is to be played at a second terminal device to the at least one client terminal, so that the client terminal, according to the notification message, provides a prompt message of the target event and presents an item to initiate the multi-display interaction request at a user interface of the first terminal device.

The present disclosure provides an example client device for multi-display interaction. For example, a first terminal device comprises:

one or more processors; and

one or more memories storing thereon computer-readable instructions that, when executed by the one or more processors, cause the one or more processors to perform acts comprising:
starting an image capture apparatus at the first terminal device when receiving a multi-display interaction request, to capture an image of a target display interface at a second terminal device;
determining a target event and target material information correlated with the target event, the target event being displayed at the second terminal device; and
providing the target material information and a corresponding animation effect with the image, the corresponding animation effect animating a process of the target material information leaving a display of the second terminal device and entering a display of the first terminal device, the providing the target material information and the corresponding animation effect with the image includes:
   providing an animation effect that the target material information moves along a direction from the display of the second terminal device to the display of the first terminal device;
   providing an animation effect of a first screen hit that the target material information hits the display of the second terminal device and leaves the second terminal device; and
   providing an animation effect of a second screen hit that the target material information hits the display of the first terminal device and enters the first terminal device

### BRIEF DESCRIPTION OF THE DRAWINGS

In order to illustrate the technical solutions in the example embodiments of the present disclosure more clearly, the drawings for illustrating the example embodiments are briefly introduced as follows. One of ordinary skill in the art may obtain other figures according to the FIGs without using creative efforts.

FIG. 1 is a diagram of a system according to an example embodiment of the present disclosure;

FIG. 2 is a flowchart of a method applicable at a client terminal according to an example embodiment of the present disclosure;

FIGS. 3(A) to 3(F) are diagrams of user interfaces according to an example embodiment of the present disclosure;

FIG. 4 is a flowchart of a method applicable at a server according to an example embodiment of the present disclosure;

FIG. 5 is a diagram of a client device according to an example embodiment of the present disclosure;

FIG. 6 is a diagram of an electronic device according to an example embodiment of the present disclosure;

FIG. 7 is a diagram of a server apparatus according to an example embodiment of the present disclosure.

### DETAILED DESCRIPTION

In conjunction with the following FIGs of the present disclosure, the technical solutions of the present disclosure will be described. Apparently, the described example embodiments merely represent some of the example embodiments of the present disclosure and are not to be construed as limiting the present disclosure. All other example embodiments obtained by those of ordinary skill in the art based on the example embodiments of the present disclosure fall within the scope of protection of the present disclosure.

The present disclosure provides an example method for multi-display interaction, which includes:

A client terminal starts an image capture apparatus at a first terminal device when the client terminal receives a multi-display interaction request, to capture an image of a target display interface at a second terminal device. The client terminal may be located at the first terminal device.

The client terminal determines a target event and target material information correlated with the target event. The target event is displayed at the second terminal device.

The client terminal provides the target material information and corresponding animation effects with the image captured by the image capture apparatus. The corresponding animation effects animate a process of the target material information leaving the display at the second terminal device and entering a display of the first terminal device.

The present disclosure also provides another example method for multi-display interaction, which includes:

A server determines at least one client terminal that participates in multi-display interaction.

The server determines play progress information at a second terminal device.

After determining that the second terminal device is displaying a target event, the server provides target material information correlated with the target event to at least one client terminal so that a client terminal provides the target material information and corresponding animation effects with the image captured by an image capture apparatus at a first terminal device. The corresponding animation effects animate a process of the target material information leaving the display at the second terminal device and entering a display of the first terminal device.

The present disclosure also provides an example apparatus for multi-display interaction, which is applicable at a client terminal and includes:

a request receiving unit that starts an image capture apparatus at a first terminal device when the client terminal receives a multi-display interaction request, to capture an image of a target display interface at a second terminal device;

a material information determining unit that determines a target event and target material information correlated with the target event. The target event is displayed at the second terminal device.

a material information providing unit that provides the target material information and corresponding animation effects with the image captured by the image capture apparatus. The corresponding animation effects animate a process of the target material information leaving the display at the second terminal device and entering a display of the first terminal device.

The present disclosure also provides an example electronic device, which includes:

one or more input/output interface(s) including a display;

one or more processors; and

one or more computer readable media that store thereon computer-readable instructions for implementing multi-display interaction that, when executed by the one or more processors, cause the one or more processors to perform acts including: starting an image capture apparatus at a first terminal device when receiving a multi-display interaction request, to capture an image of a target display interface at a second terminal device; determining a target event and target material information correlated with the target event, wherein the target event is displayed at the second terminal device; and providing the target material information and corresponding animation effects with the image captured by the image capture apparatus. The corresponding animation effects animate a process of the target material information leaving the display at the second terminal device and entering a display of the first terminal device

The present disclosure also provides an example apparatus for multi-display interaction, which is applicable at a server and includes:

a client terminal determining unit that determines at least one client terminal that participates in multi-display interaction;

a play progress determining unit that determines play progress information at a second terminal device; and

a material information providing unit that, after determining that the second terminal device is displaying a target event, provides target material information correlated with the target event to at least one client terminal so that a client terminal provides the target material information and corresponding animation effects with the image captured by an image capture apparatus at a first terminal device. The corresponding animation effects animate a process of the target material information leaving the display at the second terminal device and entering a display of the first terminal device.

Through the example embodiments of the present disclosure, the present disclosure discloses the following technical effects:

During the process of multi-display interaction, a client terminal starts an image capture apparatus at a first terminal device when the client terminal receives a multi-display interaction request, to capture an image of a target display interface at a second terminal device. The client terminal may be located at the first terminal device. The client terminal determines a target event and target material information correlated with the target event. The target event is displayed at the second terminal device. The client terminal provides the target material information and corresponding animation effects with the image captured by the image capture apparatus. The corresponding animation effects animate a dynamic process of the target material information leaving the display at the second terminal device and entering a display of the first terminal device. Thus, the techniques of the present disclosure provide more realistic effect of interaction and deliver higher user engagement.

Certainly, a product that implements the present disclosure does not need to have all of the above technical advantages.

In an example embodiment of the present disclosure, during the process of multi-screen display, a first terminal device starts an image capture apparatus to capture an image of a target display interface at a second terminal device; determines a target event and target material information correlated with the target event, wherein the target event is displayed at the second terminal device; and providing the target material information and corresponding animation effects with the image captured by the image capture apparatus. The corresponding animation effects animate a process of the target material information leaving the display at the second terminal device and entering a display of the first terminal device. The techniques of the present disclosure provide more realistic and more three-dimensional effect of interaction and deliver higher user engagement.

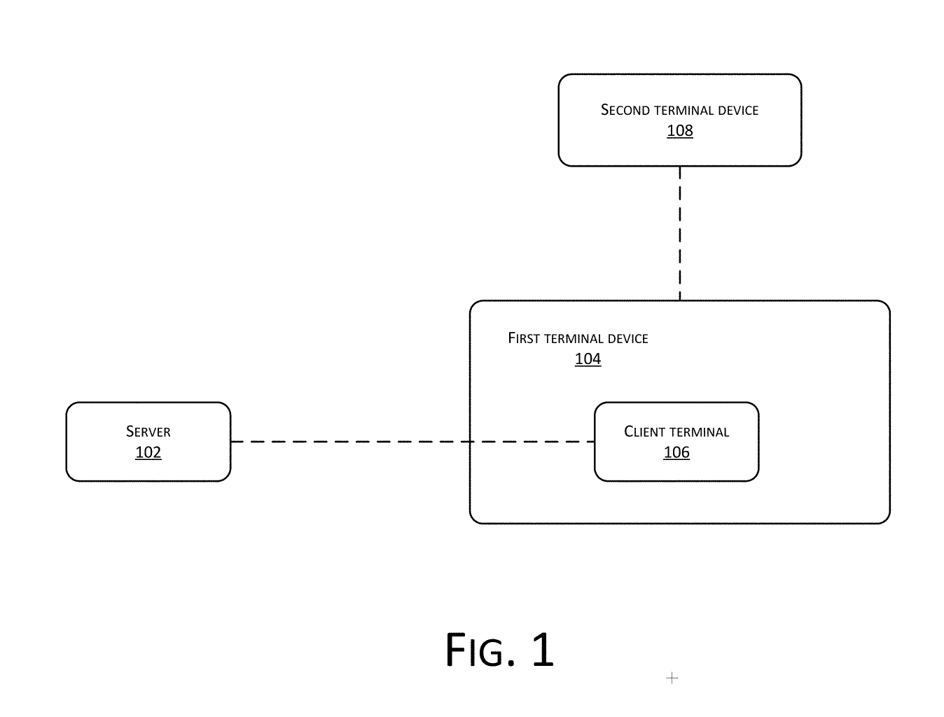

From a perspective of system structure, referring to FIG. 1, an example system includes a server 102, a first terminal device 104 to which a client terminal 106 is installed, and a second terminal device 108 that plays media content, such as a TV. For example, the server may be a server for an online platform, such as Tmall. Correspondingly, the client terminal may be a client terminal of the platform that is installed on the terminal device and communicates with the server, such as a Tmall client installed on a smart phone. The first terminal device may be a phone, a tablet, etc. of a user. The second terminal device may be a TV, etc. For example, the online platform and a TV station host a celebration party. During the process that the TV station broadcasts the party, the user may use the client terminal installed at the cell phone to have multi-display interaction with the TV.

The following describes the example detailed implementations.

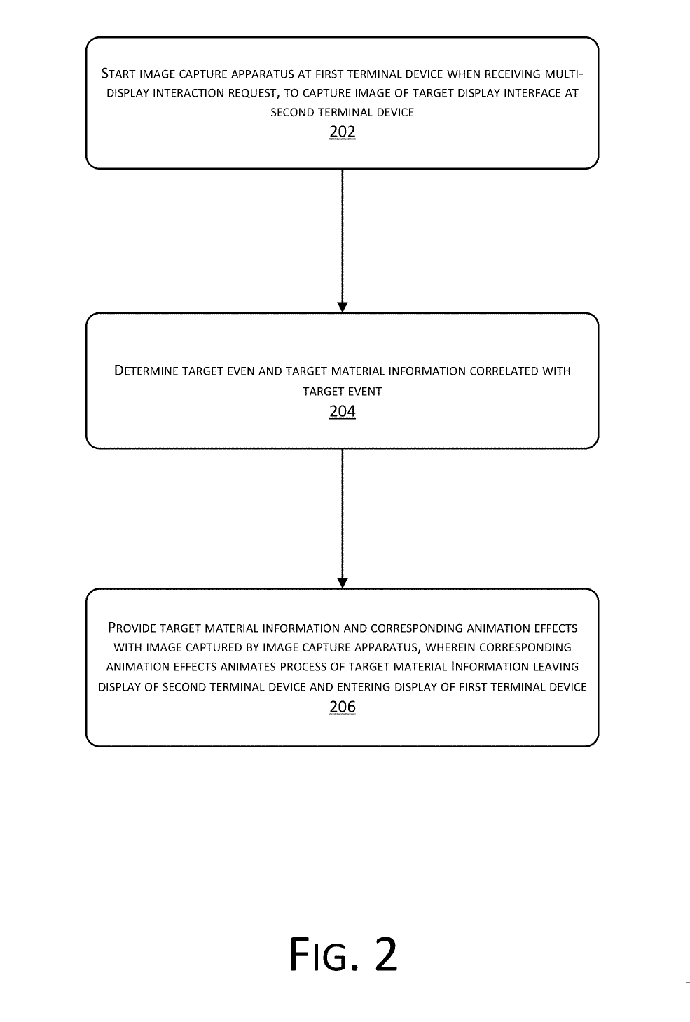

A first example embodiment, from the perspective of the client terminal, provides a method for multi-display interaction. Referring to FIG. 2, the method includes the following operations:

At 202, a client terminal starts an image capture apparatus at a first terminal device when the client terminal receives a multi-display interaction request, to capture an image of a target display interface at a second terminal device. The client terminal may be located at the first terminal device.

A user interface of the client terminal provides the operation items to start the multi-display interaction. For example, at a home page for the celebration party, such as the double 11 celebration party, corresponding buttons are provided. The client terminal starts the image capture apparatus at the first terminal device when the client terminal receives a multi-display interaction request, to capture an image of a target display interface at a second terminal device.

For example, in a specific implementation, it is not necessary to conduct multi-display interaction any time. For instance, during the process of the celebration party, there are some interactive programs or games. When the time for such interactive programs or games comes, the interaction begins. The user may obtain the information for interaction in various ways. For example, a host of the party may reminder the user of the interaction. Assuming that the user is watching the party played at the second terminal device, the host remind the user to have the cell phone for interaction when the interactive programs is to begin. For instance, the user may open the client terminal at the first terminal device, visit the home page of the party, and click a related button to send the multi-display interaction request. The client terminal may start the camera or other image capturing apparatus at the first terminal device to capture the image of the target display interface at the second terminal device.

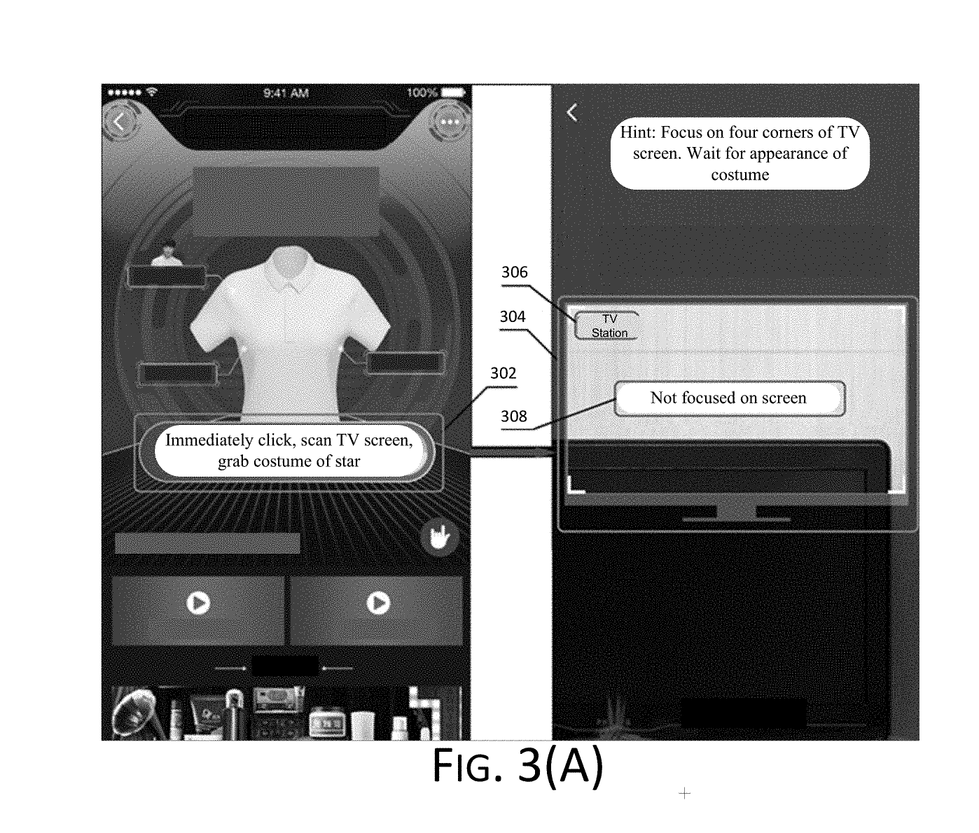

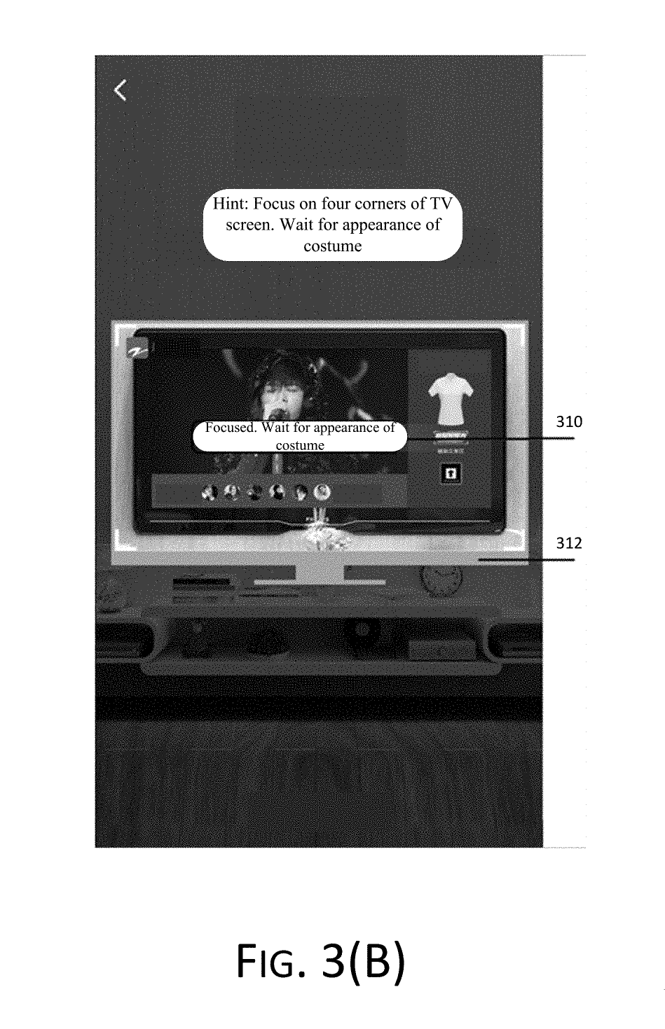

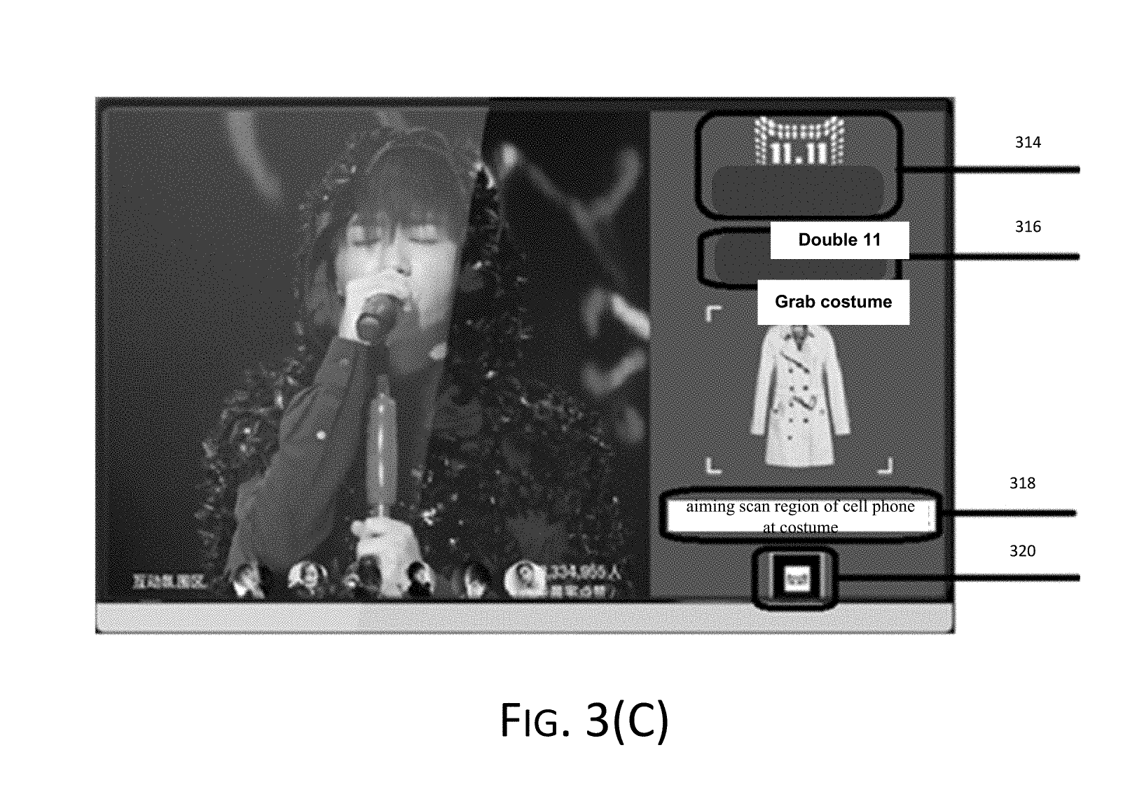

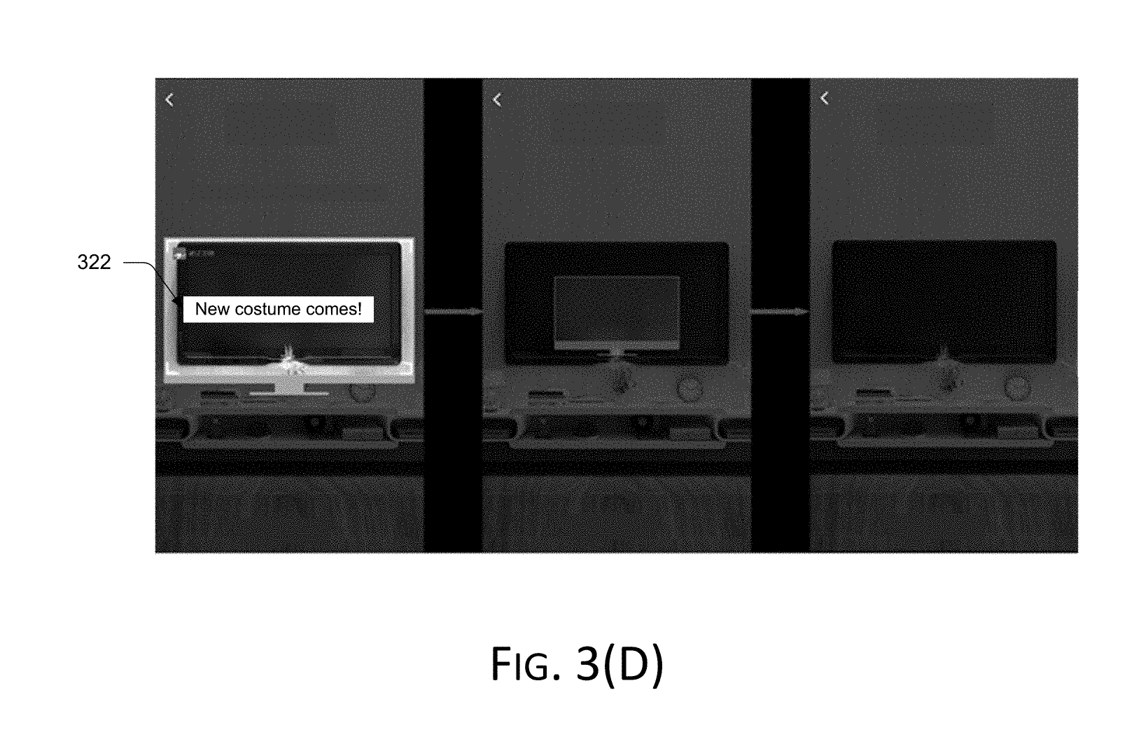

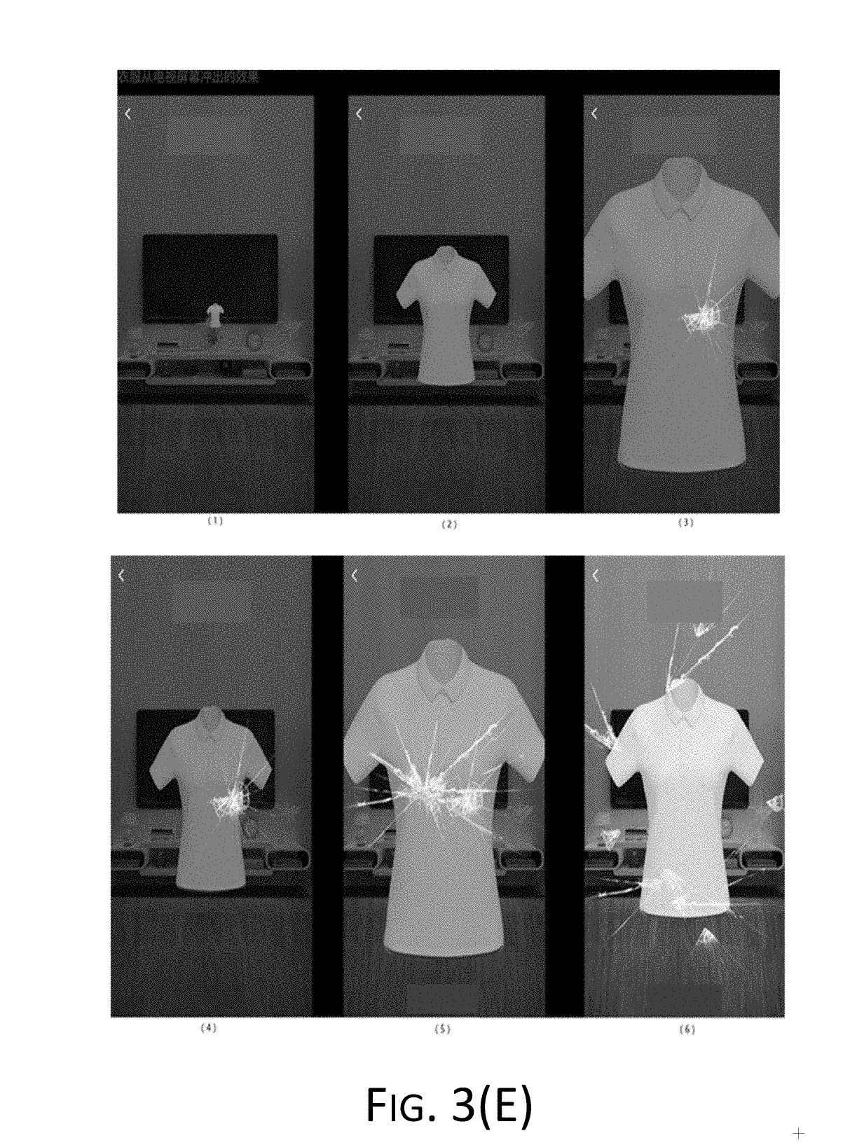

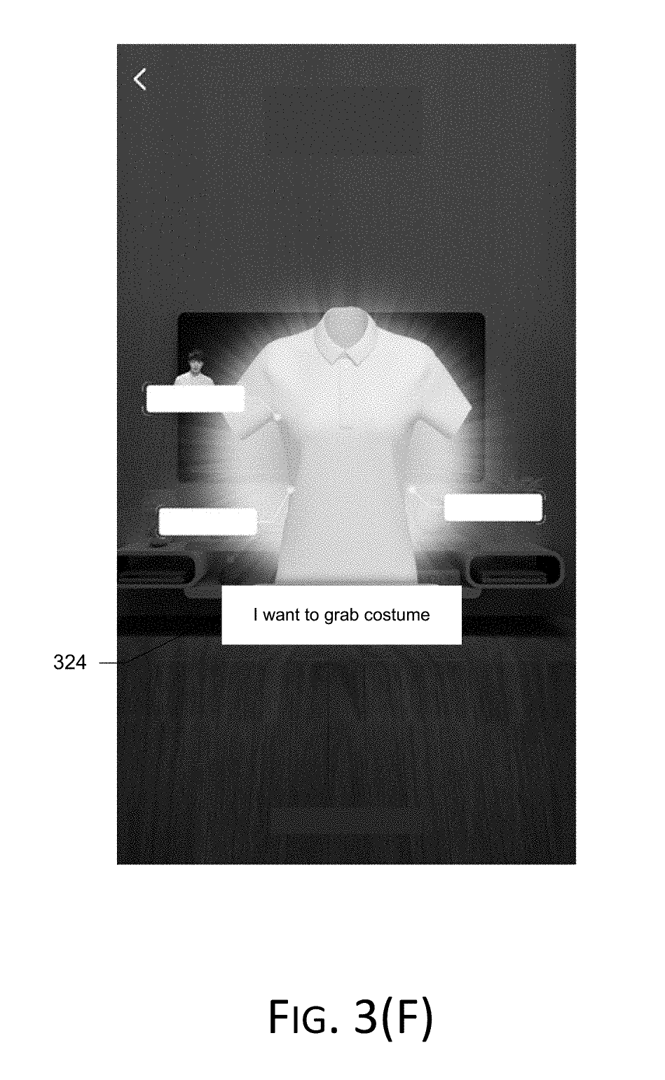

Alternatively, in another example implementation, if the user is using the client terminal to conduct other operation such as surfing Internet, and does not watch the party via TV. The server pushes relevant information to the client terminal, reminds the user to open the TV, switches to the target station, and participates in the multi-display interaction. For example, the server may obtain the program list of the party in advance, predicts an occurrence time of a target event according to the program list, and prompts a reminder to the user via the client terminal at the occurrence time. Alternatively, the celebration party is live broadcast. During the broadcast, due to some emergency, the actual programs are not conducted strictly according to the program list. Thus, an administrator may watch the program progress at the field of the celebration party, and input corresponding information into the server when the target event is to begin. Thus, the server obtains the occurrence of the target event and provides corresponding prompt message to the client terminal. For example, the target event is an action that an actor throws a cloth during performance. At that time, the client terminal receives a message relating to throwing cloth, and an interactive webpage displays a button that prompts the user to click to grab the cloth in a virtual form. The user may click the button from the interactive page to enter a scan mode. For example, the prompt message may be as shown in item 302 of FIG. 3(A), “Immediately click, scan the TV screen, grab the costume of star.” Thus, the user may click such operation item or button to send the multi-display interaction request.

After starting the image capture apparatus at the first terminal device, the user may need some time to adjust the position of the first terminal device and the distance from the second terminal device to aim at the display of the second terminal device. Thus, in an example implementation, the time prompting the message may be earlier than the actual occurrence time of the target event within a preset threshold, such as a few minutes earlier. If the host broadcast the message to remind the user to participate in the interaction, the host may broadcast such message in advance. If the server notifies the user to participate in the interaction, the administrator may predict the time of the interactive program according to the actual play progress, so that the server sends the prompt message to the user in advance. In addition, the live show may be broadcast with delay. That is, the contents viewed by the user before the TV are delayed a preset time period than the actual performance time (such as 1 minute). Thus, even if the administrator instructs the server to send the prompt message to the user after the administrator watches the target event occurred at the field, it is still feasible as the time that the time that the target event is displayed at the terminal device is one minute after the occurrence of the target event.

After the image capture apparatus of the first terminal device is started, the capture area is aimed at the target display interface of the second terminal device. The target display interface may refer to a display interface of the target station. The client terminal may assist the user to perform the aiming process, such as auto-focus.

For example, to help the user correctly capture the image, a virtual graph representing the exterior shape of the second terminal device is presented at the user interface for capturing image to guide the user to adjust the position of the first terminal device and its distance from the second terminal device to correctly aim at the display of the second terminal device. As shown in FIG. 3, 304 indicates a virtual graph. When the second terminal device is the TV, the virtual graph may imitate the exterior shape of the TV and represent the TV. Thus, the user may quickly understand the object to be scanned is TV. In addition, as a specific program is often played at a specific station. An icon representing the target station may be presented in the virtual graph to suggest the user to quickly switch to the target station. For example, in FIG. 3, an icon 306 representing the target station such as the Zhejiang TV station is displayed. That is, the interactive program that the user needs to participate is played at the Zhejiang TV station. The icon 306 representing the Zhejiang TV station is placed at the top left corner. In addition, the inner side of the four corners of the virtual graph may be emphasized to suggest to the user that the edge of the scan region is the inner side of the virtual graph. Thus, through the user of the virtual graph and icon representing the TV station, the prompt message reminds the user that the object to be scanned is the TV and the target display interface to be scanned is the program of Zhejiang TV station.

The prompt message together with the virtual graph direct the user to operate, to open TV, to switch to the target TV station, and to aim the camera of the cell phone at the screen of the TV. Thus, the screen enters the capture range of the camera of the cell phone. Whether the aim is accurate may be left the user to determine. In addition, the client terminal may use various method to determine the aiming result. If the aim is not focused, the client terminal may prompt a message “not focused on the screen” as shown in 308 in FIG. 3(A). The user, through such prompt message, understands that the scanned object is not focused and adjust the position of the first terminal device, and/or the distance from the first terminal device to the second terminal device. For example, after the image capture apparatus of the first terminal device focuses on the display of the second terminal device, the presentation of the virtual graph may be changed to indicate that the position of the first terminal device is correctly adjusted. For example, the initial color of the virtual graph is gray. After the client terminal determines that the image capture apparatus focuses on the screen of the TV, the color of the virtual graph is changed to blue. The previous prompt message reminding focus problem is changed to the feedback message that the focus is correct, or the prompt message to remind the user to wait for the occurrence of the target event. For example, as shown in 310 of FIG. 3(B), the prompt message is updated to “Focused. Wait for the appearance of the costume.” In addition, as shown in 312 of FIG. 3(B), the color of the virtual graph is changed.

There are various methods to adjust the focusing or aiming of the image capture apparatus. For example, the target display interface of the second terminal device may display some key element information, such as graphic symbol information (such as the logo in the celebration party, the brand in the interactive program) and/or guiding text information. For example, FIG. 3(C) shows the content displayed at the target display interface of the second terminal device. 314 is the logo of the double 11 activity, 316 is the name of the current interactive program, such as a game called “grab costume,” 318 is the guiding text information such as “aiming scan region of cell phone at costume”, 320 is the bar code information. The client terminal may analyze the content of the image captured by the image capture apparatus to identify the key element information, and determines whether the image capture apparatus such as the camera of the first terminal device focuses on the target display interface of the second terminal device depending on whether such key element information is identified. For instance, if the first terminal device is too close or too far away from the second terminal device, the client terminal at the first terminal device cannot identify the key element information. Then the user interface of the client terminal provides real time feedback that the camera does not focus.

At 204, the client terminal determines the target event and the target material information correlated with the target event. The target event, the correlated target material information, or both are displayed at the second terminal device.

After the focusing completes, the client terminal may use various methods to determine whether the second terminal device is playing the target event and determines the target material information corresponding to the target event.

For example, the client terminal pre-stores a model established for an image at the target event. The client terminal analyzes the content of the image captured by the first terminal device. If the image conforms with the model, the client terminal determines that the target event occurs at the second terminal device.

For another example, the client terminal receives a notification message from the server to determine that the target event occurs at the second terminal device. For instance, the administrator of the server is watching the celebration party at the field. When the target event occurs, the server is instructed to send the notification message to the client terminal. There may be some network delay during the process that the server sends the notification message to the client terminal. Due to the characteristics of the delayed broadcast such that the target event occurred at the field may be delayed for a preset time such as one minute to be played at the second terminal device, the impact of the network delay is ignored. For instance, when the administrator at the field discovers that the actor throws the costume at 20:29, the server is instructed to the client terminal that the corresponding target event occurs at 20:30 at the second terminal device.

The target material information correlated with the target event may be pre-stored at the server and provided to the client terminal by the server. For example, the server may include the target material information in the notification message of the target event. For another example, the server may transmit or push the target material information to the client terminal in advance to be stored or cached at the client terminal. The detailed material related information may include figure of the material to present the target material at the interface of the client terminal.

At 206, the client terminal provides the target material information and corresponding animation effects with the image captured by the image capture apparatus. The corresponding animation effects animate a process of the target material information leaving the display of the second terminal device and entering a display of the first terminal device.

After determining that the second terminal device is displaying a target event and determining the target material information correlated with the target event, the client terminal provides the target material information and corresponding animation effects with the image captured by the image capture apparatus at the first terminal device. The corresponding animation effects animate a dynamic process of the target material information leaving the display at the second terminal device and entering a display of the first terminal device. For example, assuming that the target event is that an actor performs an operation to “throw a costume,” and the corresponding target material is a picture of the costume. When the TV is determined to play the target event, the animation process that the picture of the costume leaves the screen of the TV and enters the screen of the first terminal device as the cell phone is displayed at the user interface of the cell phone.

For example, when the second terminal is playing the target event, the client terminal provides the prompt message relating to the target material that is to appear, reminds the user via the first terminal device such as opening a shake mode of the first terminal device, and/or reminds the user via the second terminal device such as presenting text in the virtual graph at the user interface of the second terminal device to reminder the user. For example, as shown in FIG. 3(D), the prompt message “New costume comes!” 322 is presented at the user interface of the second terminal device in the left figure. Furthermore, the virtual graph may be minimized until invisible. For example, in FIG. 3(D), the virtual graph is reduced in the middle figure and disappears in the right figure. In FIG. 3(D), the contents on the user interface of the second terminal

For example, when providing the animation effect of the target material, the techniques of the present disclosure provide the animation effect that the target material moves along a direction from the screen of the second terminal device to the screen of the first terminal device. To achieve more realistic effect, the animation effect that the target material hits the screen may also be provided. In an example implementation, the effect of hitting the screen may occur twice. The first hit animates that the target material hits the screen of the second terminal device and leave the second terminal device. The second hit animates that the target material hits the screen of the first terminal device and enters the first terminal device.

FIG. 3(E) shows six example statuses during the moving process of the target material. (1) shows the status that the picture of the costume starts to move out of the screen of the TV. (2) shows the status that the picture of the costume is enlarged and is ready to move out of the screen of the TV. (3) shows the status which is the broken effect when the costume hits the screen of the TV at the first time. (4) shows the status that the picture of the costume moves back towards the screen of the TV. (5) shows the status that the picture of the costume hits the screen of the cell phone at the second time. (6) shows that the status that the broken screen disappears such that the picture of the costume falls off from the edge of the screen of the cell phone. Through such change of the statuses, the interactive effect that one cloth flies out of the screen of the TV and flies into the user interface of the cell phone is achieved, which improves user engagement. After the animation process ends, the displayed interface is shown in FIG. 3(F). A button “I want to grab costume” 324 is presented at the user interface for the user to participate in the following activities. For example, after the user clicks the button 324, the user obtains the ticket for lottery, etc.

In the example embodiment of the present disclosure, the program played at the second terminal device may be live show or recorded program. With respect to the recorded program, as the time of each event in the program is already known, the implementation would be simpler. In addition, the target material, when the server is an online e-commerce platform, may also be specific data object representing a product or service at the e-commerce platform. After completing a series of interaction and animated presentation, the user may directly view or purchase the product or service at the first terminal device.

In this example embodiment of the present disclosure, during the process of multi-display interaction, a client terminal starts an image capture apparatus at a first terminal device to capture an image at a target display interface at a second terminal device. The client terminal may be located at the first terminal device. The client terminal determines a target event and target material information correlated with the target event. The target event is displayed at the second terminal device. The client terminal provides the target material information and corresponding animation effects with the image captured by the image capture apparatus. The corresponding animation effects animate a dynamic process of the target material information leaving the display at the second terminal device and entering a display of the first terminal device. Thus, the techniques of the present disclosure provide more realistic effect of interaction and deliver higher user engagement.

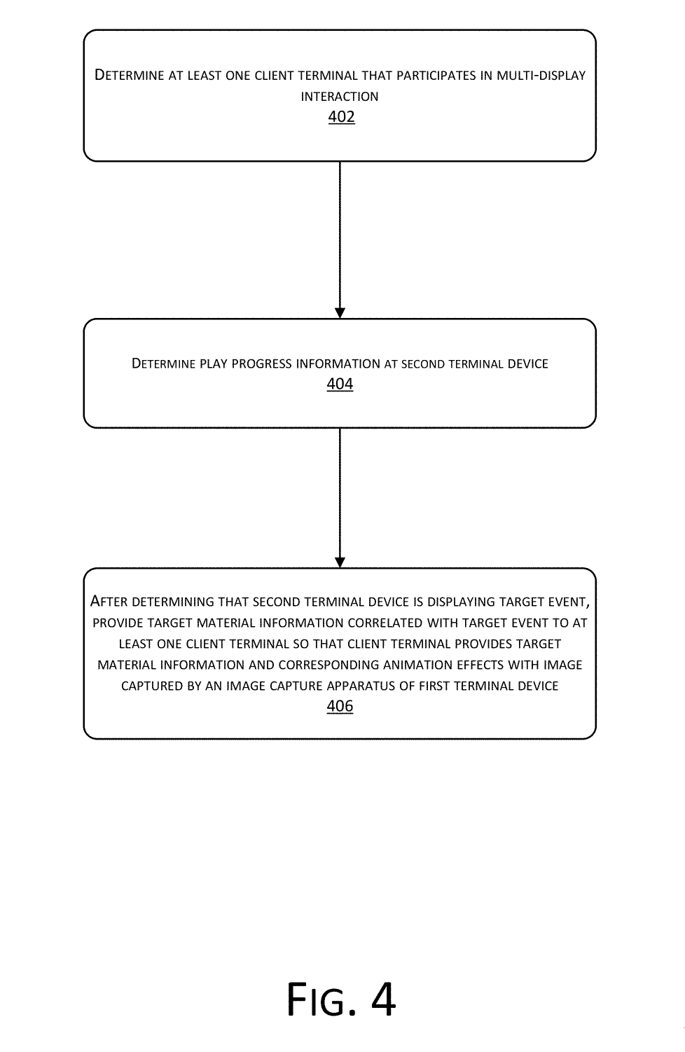

Corresponding to the first example embodiment, a second example embodiment, from the perspective of the server provides a method for multi-display interaction. Referring to FIG. 4, the method includes the following operations:

At 402, a server determines at least one client terminal that participates in multi-display interaction.

For example, before determining the at least one client terminal that participates in multi-display interaction, the server may provide a notification message that a target event is to be played at the second terminal device to the at least one client terminal. Thus, the client terminal, according to the notification message, provides a prompt message of the target event at its user interface, and presents an item to initiate the multi-display interaction request at its user interface.

At 404, the server determines play progress information at the second terminal device.

At 406, after determining that the second terminal device is displaying the target event, the server provides target material information correlated with the target event to at least one client terminal so that the client terminal provides the target material information and corresponding animation effects with the image captured by an image capture apparatus of the first terminal device. The corresponding animation effects animate a process of the target material information leaving the display at the second terminal device and entering a display of the first terminal device.

As the second example embodiment corresponds to the first example embodiment, the implementation may refer to the description in the first example embodiment, which is not detailed herein for brevity.

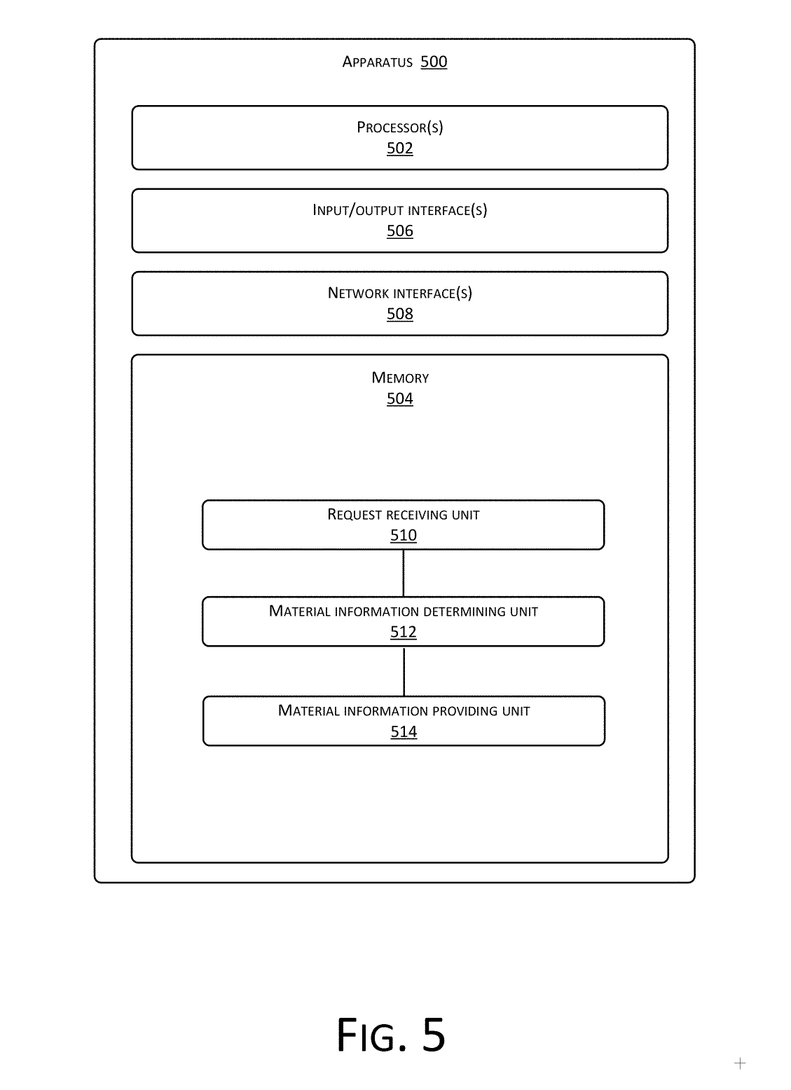

Corresponding to the first example embodiment, the present disclosure also provides an apparatus for multi-display interaction. The apparatus is applied at the client terminal. As shown in FIG. 5, an apparatus 500 includes one or more processor(s) 502 or data processing unit(s) and memory 504. The apparatus 500 may further include one or more input/output interface(s) 506 and one or more network interface(s) 508. The memory 504 is an example of computer readable media.

The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

The memory 504 may store therein a plurality of modules or units including:

a request receiving unit 510 that starts an image capture apparatus at a first terminal device when the client terminal receives a multi-display interaction request, to capture an image at a target display interface at a second terminal device;

a material information determining unit 512 that determines a target event and target material information correlated with the target event. The target event is displayed at the second terminal device.

a material information providing unit 514 that provides the target material information and corresponding animation effects with the image captured by the image capture apparatus. The corresponding animation effects animate a process of the target material information leaving the display at the second terminal device and entering a display of the first terminal device.

For example, the memory 504 may further store therein the following units (not shown in FIG. 5):

a notification message receiving unit that receives a notification message provided by the server that the second terminal device is to display the target event; and

a prompting unit that, according to the notification message, provides a prompt message of the target event at a user interface, and presents an item to initiate the multi-display interaction request at the user interface.

To facilitate the user to aim the first terminal device at the second terminal device, the memory 504 may further store therein the following units (not shown in FIG. 5):

a virtual graph providing unit that provides a virtual graph representing the exterior shape of the second terminal device at the user interface for capturing image to guide the user to adjust the position of the first terminal device and its distance from the second terminal device to correctly aim at the display of the second terminal device.

For example, the second terminal device includes a TV.

The memory 504 may further store therein a station icon providing unit that provides an icon representing a target program source, such as a target TV station, within the virtual graph to guide the user to switch to the target program source.

For example, the memory may further store therein the following units (not shown in FIG. 5):

a feedback information providing unit that changes the presentation of the virtual graph to provide the feedback information when the image capture apparatus of the first terminal device focuses on the second terminal device;

a material information prompting unit that provides prompt information that the target material information is to appear at the user interface when determining that the target event is being played at the second terminal device. The material information prompting unit may also minimize the virtual graph to be invisible.

For example, the material information providing unit may open the shaking mode of the first terminal device to remind the user, and/or provide content such as text in the virtual graph to remind the user.

For example, the memory may further store therein the following units (not shown in FIG. 5):

a determining unit that determines whether the image capture apparatus of the first terminal device focuses on the display of the second terminal device based on the image captured by the image capture apparatus of the first terminal device;

a focusing result prompting unit that provides a corresponding prompt message when the image capture apparatus of the first terminal device does not focus on the display of the second terminal device.

For example, key element information is displayed at a preset region of a target display interface. The determining unit may include the following units (not shown in FIG. 5):

an analyzing sub-unit that analyzes the content of the image captured by the image capture apparatus; and

a key element determining sub-unit that determines whether the content of the image includes the key element information and determines that the image capture apparatus focuses on the display of the second terminal device in response to determining that the content of the image includes the key element information.

For example, the key element information includes preset representative graph information and/or text information.

For example, the material information providing unit 514 may

provide the animation effect that the target material moves along a direction from the screen of the second terminal device to the screen of the first terminal device. To achieve more realistic effect, the animation effect that the target material hits the screen may also be provided.

In an example implementation, the effect of hitting the screen may occur twice. The first hit animates that the target material hits the screen of the second terminal device and leave the second terminal device. The second hit animates that the target material hits the screen of the first terminal device and enters the first terminal device.

For example, the target event being displayed at the second terminal device is a live show or live broadcast.

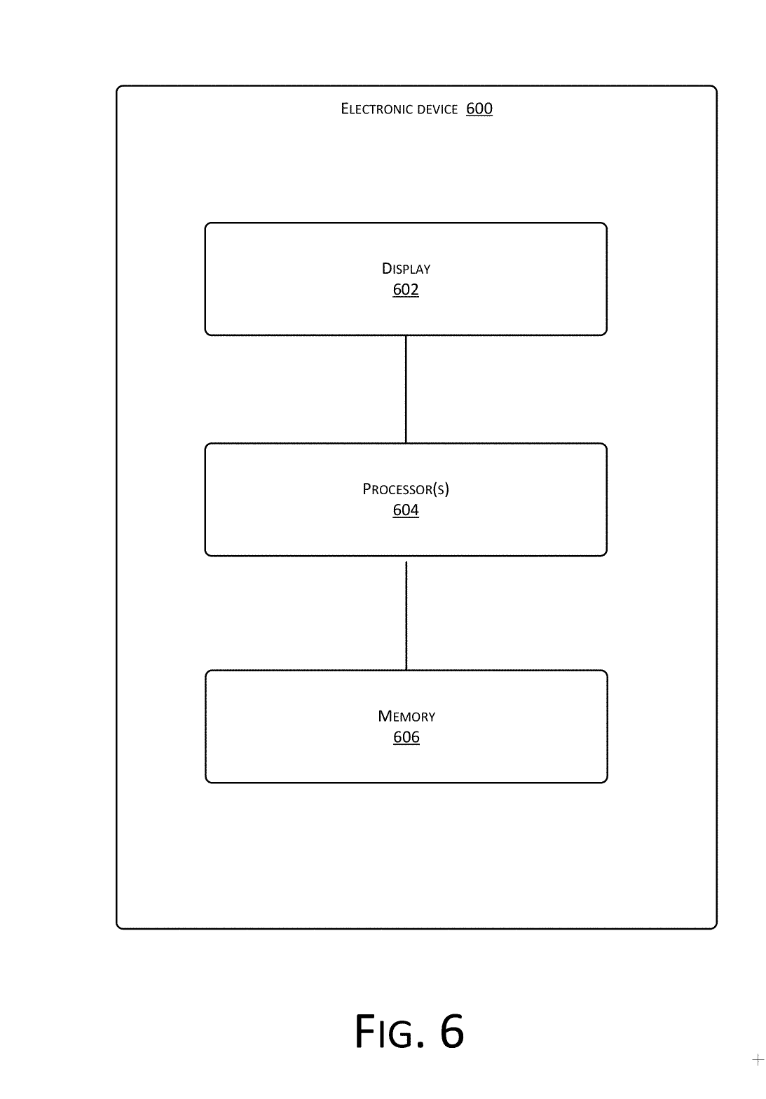

Corresponding to the above apparatus, the present disclosure also provides an electronic device 600 as shown in FIG. 6. The electronic device 600 includes:

a display 602;

one or more processors 604; and

one or more memory 606 that store thereon computer-readable instructions for implementing multi-display interaction that, when executed by the one or more processors, cause the one or more processors to perform acts including: starting an image capture apparatus at a first terminal device when receiving a multi-display interaction request, to capture an image of a target display interface at a second terminal device; determining a target event and target material information correlated with the target event, wherein the target event is displayed at the second terminal device; and providing the target material information and corresponding animation effects with the image captured by the image capture apparatus. The corresponding animation effects animate a process of the target material information leaving the display at the second terminal device and entering a display of the first terminal device

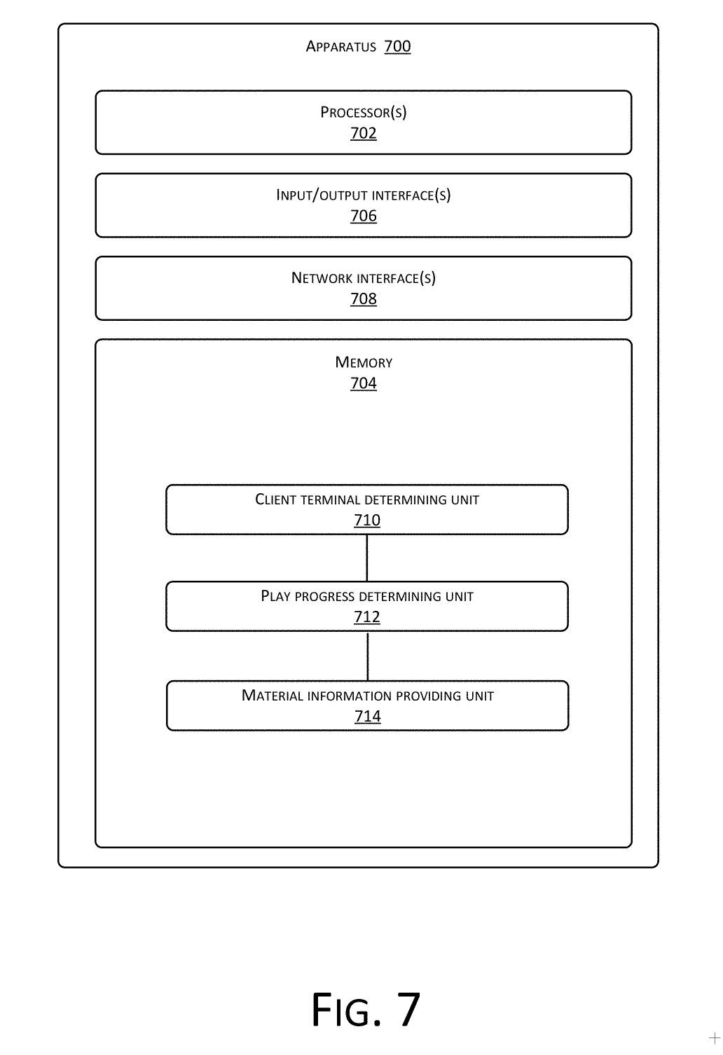

Corresponding to the second example embodiment, the present disclosure also provides another apparatus for multi-display interaction. Such apparatus may be applied to the server. As shown in FIG. 7, an apparatus 700 includes one or more processor(s) 702 or data processing unit(s) and memory 704. The apparatus 700 may further include one or more input/output interface(s) 706 and one or more network interface(s) 708. The memory 704 is an example of computer readable media.

The memory 704 may store therein a plurality of modules or units including:

a client terminal determining unit 710 that determines at least one client terminal that participates in the multi-display interaction;

a play progress determining unit 712 that determines play progress information at a second terminal device; and

a material information providing unit 714 that, after determining that the second terminal device is displaying a target event, provides target material information correlated with the target event to at least one client terminal so that a client terminal provides the target material information and corresponding animation effects with the image captured by an image capture apparatus at a first terminal device. The corresponding animation effects animate a process of the target material information leaving the display at the second terminal device and entering a display of the first terminal device.

For example, the memory may further store therein the following units (not shown in FIG. 7):

a notifying unit that provides a notification message that the target event is to be played at the second terminal device to the at least one client terminal, so that the client terminal, according to the notification message, provides a prompt message of the target event at its user interface, and presents an item to initiate the multi-display interaction request at its user interface.

During the process of multi-display interaction, a client terminal starts an image capture apparatus at a first terminal device when the client terminal receives a multi-display interaction request, to capture an image of a target display interface at a second terminal device. The client terminal may be located at the first terminal device. The client terminal determines a target event and target material information correlated with the target event. The target event is displayed at the second terminal device. The client terminal provides the target material information and corresponding animation effects with the image captured by the image capture apparatus. The corresponding animation effects animate a dynamic process of the target material information leaving the display at the second terminal device and entering a display of the first terminal device. Thus, the techniques of the present disclosure provide more realistic effect of interaction and deliver higher user engagement.

Based on the description of the above example embodiments, one of ordinary skill in the art would understand that the present disclosure may be implemented by software and necessary general-purpose hardware. Based on this understanding, the technical solution of the present disclosure may be embodied in the form of a software product which may be stored in nonvolatile storage medium (such as ROM/RAM, magnetic disk, CD-ROM) which store computer-readable instructions that enable a computing device (such as a personal computer, a server, or a network device) to perform the methods described in the various implementation scenarios of the present disclosure.

Each of the example embodiments in the present disclosure is described in a progressive manner, and the same or similar parts are referenced to each other. Each example embodiment focuses on the differences from the other example embodiments. In particular, for system, apparatus, or device example embodiments, since their performed operations are substantially similar to the method example embodiment, their descriptions are relatively simple, and the relevant portions may refer to the method example embodiment. The above described system, apparatus and device are merely illustrative, wherein the units described as separate components may or may not be physically separate, and the components shown as units may or may not be physical units, and may be located in one location or distributed to multiple network locations. Some or all of the units may be selected based on actual needs to implement one or more embodiments of the present disclosure. One of ordinary skill in the art may understand and implement the techniques of the present disclosure without using creative efforts.

The present disclosure describes the methods and devices for multi-display interaction. The principles and embodiments of the present disclosure are illustrated by example. The above example embodiments help understand the method and principles of the present disclosure. One of ordinary skill in the art may, according to the ideas and principles of the present disclosure, change the specific implementation and application scope of the techniques of the present disclosure, which shall still fall under the protection of the present disclosure. The content of the specification and drawings shall not be construed as limitation to the present disclosure.

What is claimed is:

1. A method comprising:
starting, by a client terminal, an image capture apparatus at a first terminal device when a client terminal receives a multi-display interaction request, to capture an image of a target display interface at a second terminal device;
determining a target event and target material information correlated with the target event, the target event being displayed at the second terminal device; and
providing the target material information and a corresponding animation effect with the image, the corresponding animation effect animating a process of the target material information leaving a display of the second terminal device and entering a display of the first terminal device.

2. The method of claim 1, wherein the client terminal is located at the first terminal device.

3. The method of claim 1, further comprising:
receives a notification message provided by a server that the second terminal device is to play the target event, prior to receiving the multi-display interaction request; and
presenting a prompt message regarding the target event at a user interface of the first terminal device or the second terminal device according to the notification message.

4. The method of claim 3, further comprising:
presents an item at the user interface for a user to initiate the multi-display interaction request.

5. The method of claim 1, further comprising:
providing, a virtual graph representing an exterior shape of the second terminal device at an image capture region of a user interface at the first terminal device or the second terminal device to guide.

6. The method of claim 5, wherein the virtual graph guides a user to adjust a position of the first terminal device and a distance between the first terminal device and the second terminal device to focus the image capture apparatus at the display of the second terminal device.

7. The method of claim 4, further comprising:
providing an icon within the virtual graph, the icon representing a target program source at the display of the second terminal device.

8. The method of claim 7, wherein:
the second terminal device is a TV; and
the target program source is a target TV station.

9. The method of claim 4, further comprising:
changing a presentation of the virtual graph to provide feedback information when the image capture apparatus focuses on the target display interface of the second terminal device.

10. The method of claim 4, further comprising:
providing prompt information that the target material is to appear at the user interface when determining that the target event is being played at the second terminal device
minimizing the virtual graph to be invisible.

11. The method of claim 10, wherein the providing the prompt information that the target material is to appear at the user interface includes:
open a shaking mode of the first terminal device; or
providing a content in the virtual graph.

12. The method of claim 1, further comprising:
determining that the image capture apparatus does not focus on the target display interface of the second terminal device based on an image captured by the image capture apparatus; and
providing a corresponding prompt message.

13. The method of claim 12, wherein:
a preset region in the target display interface includes key element information; and
the determining that the image capture apparatus does not focus on the target display interface of the second terminal device based on the image captured by the image capture apparatus includes:
analyzing the image;
determining that the image includes the key element information; and
determining that the image capture apparatus focuses on the target display interface of the second terminal device in response to determining that the image includes the key element information.

14. The method of claim 1, wherein the providing the target material information and the corresponding animation effect with the image includes:
providing an animation effect that the target material information moves along a direction from the display of the second terminal device to the display of the first terminal device

15. The method of claim 14, wherein the providing the target material information and the corresponding animation effect with the image further includes:
providing an animation effect of a first screen hit that the target material information hits the display of the second terminal device and leaves the second terminal device; and
providing an animation effect of a second screen hit that the target material information hits the display of the first terminal device and enters the first terminal device

16. The method of claim 1, wherein the target event is a live show or live broadcast.

17. A method comprising:
determining, by a server, at least one client terminal that participates in multi-display interaction;
determining play progress information at a second terminal device; and
in response to determining that the second terminal device is playing a target event, providing target material information correlated with the target event to the at least one client terminal.

18. The method of claim 17, further comprising:
instructing a client terminal to provide the target material information and corresponding animation effects with an image captured by an image capture apparatus at a first terminal device, the corresponding animation effects animating a process of the target material information leaving a display of a second terminal device and entering a display of the first terminal device.

19. The method of claim 17, further comprising:
providing a notification message that the target event is to be played at a second terminal device to the at least one client terminal, so that the client terminal, according to the notification message, provides a prompt message of the target event and presents an item to initiate the multi-display interaction request at a user interface of the first terminal device.

20. A first terminal device comprising:
one or more processors; and
one or more memories storing thereon computer-readable instructions that, when executed by the one or more processors, cause the one or more processors to perform acts comprising:
starting an image capture apparatus at the first terminal device when receiving a multi-display interaction request, to capture an image of a target display interface at a second terminal device;
determining a target event and target material information correlated with the target event, the target event being displayed at the second terminal device; and
providing the target material information and a corresponding animation effect with the image, the corresponding animation effect animating a process of the target material information leaving a display of the second terminal device and entering a display of the first terminal device, the providing the target material information and the corresponding animation effect with the image includes:
providing an animation effect that the target material information moves along a direction from the display of the second terminal device to the display of the first terminal device;
providing an animation effect of a first screen hit that the target material information hits the display of the second terminal device and leaves the second terminal device; and
providing an animation effect of a second screen hit that the target material information hits the display of the first terminal device and enters the first terminal device
